(19) United States
(12) Patent Application Publication
(10) Pub. No.: US 2007/0051595 A1
(43) Pub. Date: Mar. 8, 2007

(54) Method for monitoring contact consumption in multiple contact switches

(75) Inventors: Dieter Dohnal, Lappersdorf (DE); Rainer Frotscher, Regenstauf (DE)

Correspondence Address: THE FIRM OF KARL F ROSS, 5676 RIVERDALE AVENUE, PO BOX 900, RIVERDALE (BRONX), NY, 10471-0900, US

(73) Assignee: MASCHINENFABRIK REINHAUSEN GMBH, Regensburg (DE)

(21) Appl. No.: 10/578,803

(22) PCT Filed: Sep. 14, 2004
(86) PCT No.: PCT/EP04/10237

§ 371 Date: May 9, 2006

(30) Foreign Application Priority Data
Nov. 11, 2003 (DE) 103 52 580.7

(51) Int. Cl. H01H 19/00

(52) U.S. Cl. 200/11 R

(57) ABSTRACT

The invention relates to a method for monitoring contact consumption in multiple contact switches of the load-switching type, wherein the selection and the switching is carried out in one step by the movement of switching contacts and which therefore do not have a separate diverter switch. Every time the multiple contact switch is actuated, the load current is measured. The corresponding, previously stored rated stage voltages for the current switching and information on whether it was shifted “up” or “down”, are used to calculate the switching currents of the breaking contacts, the consumption rates are determined on the basis thereof and the volume consumption is accumulated. Said accumulated value is compared with a previously determined threshold value; once this threshold value is reached, warning messages or other messages are generated.

The invention relates to a method for monitoring the contact consumption in multiple contact switches.

Such a method is already known from the DE 100 03 918 C1. Therein, at any load switchover, i.e., at any actuation of the multiple contact switch, it is determined from the measured value of the load current and the respective rated stage voltage the switching currents of the respective breaking contacts and therefrom, the respective consumption rates. Subsequently, the accumulated volume consumptions of the switching contacts and resistor contacts of the diverter switch of the multiple contact switch are determined from these consumption rates and are compared to previously determined threshold values.

This known method however is in principle only applicable in such multiple contact switches in which a double-armed selector at first pre-selects in a wattless manner a new winding tap to which shall be switched over and in which subsequently a separate diverter switch switches the load current between the tap of the selector arm which is carrying current and new tap of the other selector arm. For multiple contact switches of the load-switching type, in which by means of movement of switching contacts the selecting as well as the switching function are effected in one step, which consequently do not possess a separate diverter switch, the known method however is not suitable.

It is an object of the invention to provide a method which is appropriate for the type for multiple contact switches of the load-switching type.

This object is attained by a method having the features of the independent claims 1 and 2.

In the following shall be discussed at first the general inventive idea and the device-specific backgrounds of the methods according to the invention.

Multiple contacts switches of the load-switching type are known in multiple designs from the prior art, they can in principle be subdivided into two different types, which can be distinguished according to their transition impedance. There exist load selector switches with (resistive) transition resistances as well as load selector switches with a transition reactance.

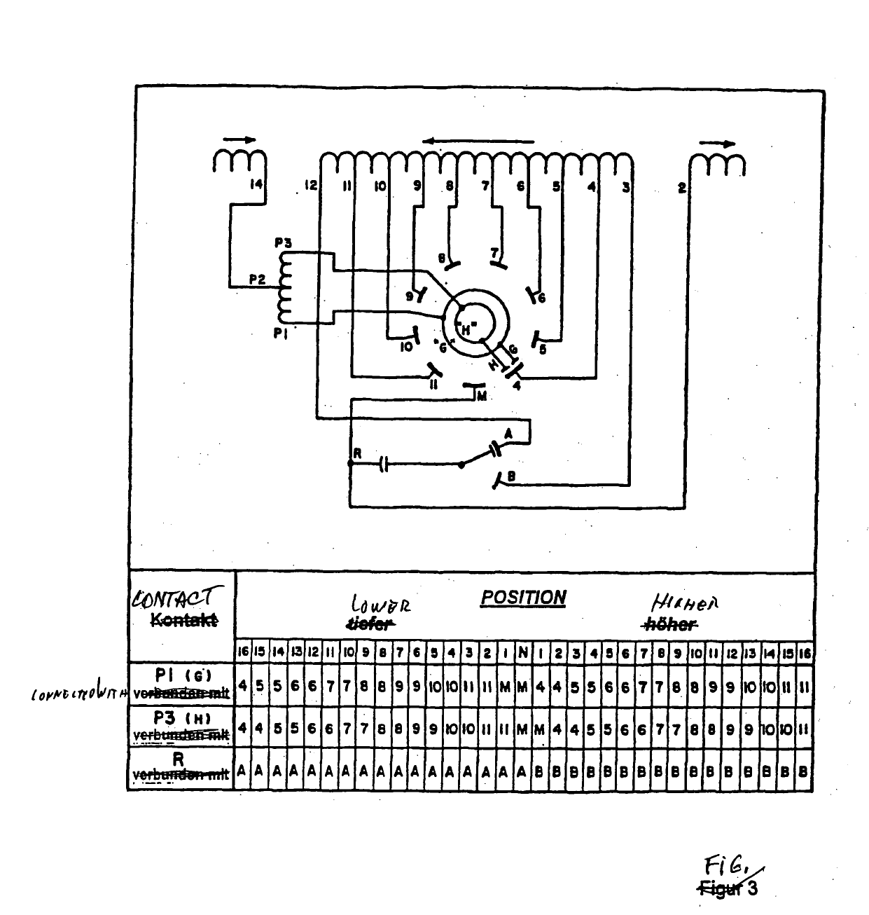

FIG. 4 shows a known load selector switch with transition resistances in schematic representation such as distributed by the applicant as type OILTAP® V. FIG. 4 shows in extracts a stage winding whose winding-taps are electrically connected to fixed stage contacts FK-m−1, FK-m, FK-m+1 of the load selector switch. Furthermore, the load selector switch has movable contacts which are commonly moved, that means, a switching contact SK as well as resistor contacts WK-A and WK-B which are disposed on both sides thereof, which are respectively connected to the load derivation via a transition resistance R₀. When switching over from the tap m to m+1, at first the resistor contact WK-B leaves the fixed stage contact FK-m. As the load current I_{L} still is conducted over the switching contact SK, the resistor contact WK-B switches off in a currentless manner, i.e. no electric arc is produced. Subsequently, the switching contact SK leaves the stage contact FK-m and commutates the load current to the resistor contact WK-A. The thus produced electric arc generates consumption on the in the figure right edge of the fixed stage contact FK-m. In the next step, the resistor contact WK-B switches up to the stage contact FK-m+1, so that due to the driving stage voltage Us a circular current flows over the two transition resistances R₀. The load current IL herein is evenly split and flows over both resistor contacts WK-A and WK-B. The final commutation of the load current to the stage contact FK-m+1 is effected by switching off the resistor contact WK-A from the fixed stage contact FK-m, whereby consumption on the resistor contact WK-A and in turn on the in the figure right edge of the fixed stage contact FK-m is generated. The switching operation is finished as soon as the switching contact SK is in contact with the fixed stage contact FK-m+1 and has taken over the load current I_{L} from the resistor contact WK-B. When switching back from the tap m+1 to m, the switching operation proceeds in exactly inverse order. Consumption in this case again occurs on the switching contact SK as well as on the resistor contact WK-B; moreover, consumption occurs on the in the figure left edge of the stage contact FK-m+1.

Since the consumption on every contact in principle depends directly on the value of the respective current which is to be switched off, it is important in the method according to the invention to determine the switching currents of all contacts involved in a switchover operation.

In the method according to the invention, therefore the following easily accessible values in each switching operation are determined: the load current I_{L}, the actual multiple contact switch position n as well as the switching direction “up” or “down,” equivalent to the multiple contact switch position n to n+1 or n+1 to n respectively. After determination of the load current I_{L}, the switching currents of the switching contact SK as well as the resistor contacts WK-A and WK-B are determined in a known manner. This is in principle known from the DE 100 03 918 C1 cited at the beginning.

Current to SK: I_{SK}=I_{L}/ParSek

Current to WK: I_{WK}=((Uₛ+I_{L})×R_{O}/sres)/2×R_{O}, wherein

Direction m→m+1: I_{WK-A=I}_{WK}
Direction m+1→m: U_{S}=−U_{S}
   I_{WK-B=I}_{WK}
      Therein, ParSek means the number of parallel sectors of the load selector switch, i.e. of the parallel connections of individual switching contacts, commonly realized in multiple planes which are horizontal disposed subjacent to each other. U_{S} represents the respective rated stage voltage and Sres the resulting current splitting on the resistor contacts WK-A and WK-B in the case of multiple parallel resistor branches. R_{O} represents the magnitude of the individual transition resistance. All these values are specific of multiple contact switches and are determined and stored as parameters of the method.

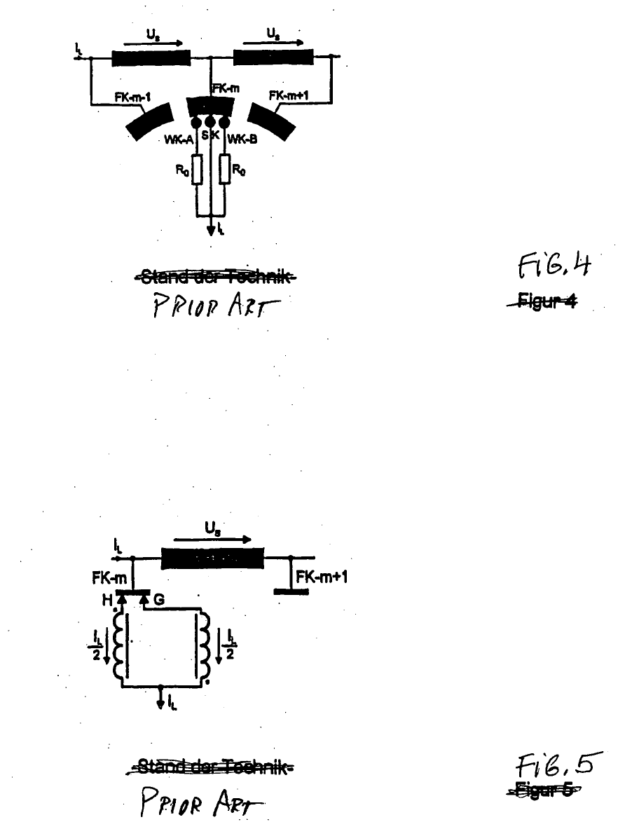

FIG. 5 shows a load selector switch with transition reactance (SVR) which is as well known from the state of the art. Multiple contact switches of this design of a load selector switch are mostly used in adjustable distribution transformers in the USA as so-called “step voltage regulators”. A range of adjustment of ±10% in ±16 stages of ⅝% respectively is generally employed. Instead of the transition resistances, a transition reactance is employed. When switching over from the tap m to m+1, the movable switching contact SK-G leaves the fixed stage contact FK-m, wherein half of the load current is commutated to the in the figure left branch and by the thus produced electric arc, consumption on the movable switching contact SK-G as well as the in the figure right flank of the stage contact FK-m occurs. The switching contact SK-G switches up to the new stage contact FK-m+1 and thus reaches the so-called “bridging position” which is a stable operating position in load selector switches of this design. The circular current driven by the stage voltage U_{S} does not generate any losses in the transition reactance, since the two winding parts which have the same size are wound in an opposite direction and due to this fact the inductions in the iron core of the reactance are neutralized. In the further process of the switching in direction m+1, the switching contact SK-H leaves the fixed stage contact FK-m and thus switches off the circular current and half of the load current; consumption occurs on the switching contact SK-H and in turn on the in the figure right side of the stage contact FK-m. Due to the switching up of the switching contact SK-H to the stage contact FK-m+1, again a non-bridging position” is reached and the switching from m to m+1 is effected. “Bridging position” and non-bridging” position respectively alternate in one direction in the continued switching. Due to the fact that, as described, the “bridging position,” that is, the medium position between two stages, is a stable operating position, different output voltages can e.g. be adjusted with a 9 stage regulating winding and superposed reversing switch 33. The grading of the output voltage therein is U_{S}/2.

In this type of load selectors switches with transition reactance, only one breaking contact exists, that means, SK-G or SK-H, which is charged according to the switching direction with different currents.

The transition reactance which is symmetrically split in two is dimensioned such that the circular circuit in the “bridging position” is typically 35% or 50% of the amount of the load current I_{L} (pa=35% or 50% respectively). Therein, the circular current is considered as being absolutely inductive. But also the load current I_{L} can have a phase displacement, which is represented by the phase angle cos φ. Typical for supply networks is a cos φ of 0.8. This value can also be indicated as so-called power factor “pf” (common in USA) in percent, e.g. pf=80%.

In the case of absolutely inductive I_{L}, pf=0%, a value which is considered in worst case considerations. Thus, the switching currents result as complex values with real and imaginary part.

Furthermore, following correlations result:

Circular current: I_{C}=I_{L}×(pa/100)

Resistive component: R=pf/100

Inductive component: X=(1−R²)^{1/2}

Thus, the switching currents are calculated as:

| | Non-bridging→bridging | Bridging→non-bridging |
|---|---|---|
| Direction | I_{SK} = I_{L}/2 | I_{SK} = (I_{L}/2) × (R − jX) − jI_{C} |
| n→n + 1 | | |
| Direction | I_{SK} = I_{L}/2 | I_{SK} = (I_{L}/2) × (R − jX) + jI_{C} |
| n + 1→n | | |

After calculation of these switching currents, the consumption on the fixed and the movable contacts can be determined.

The invention shall be further discussed in the following.

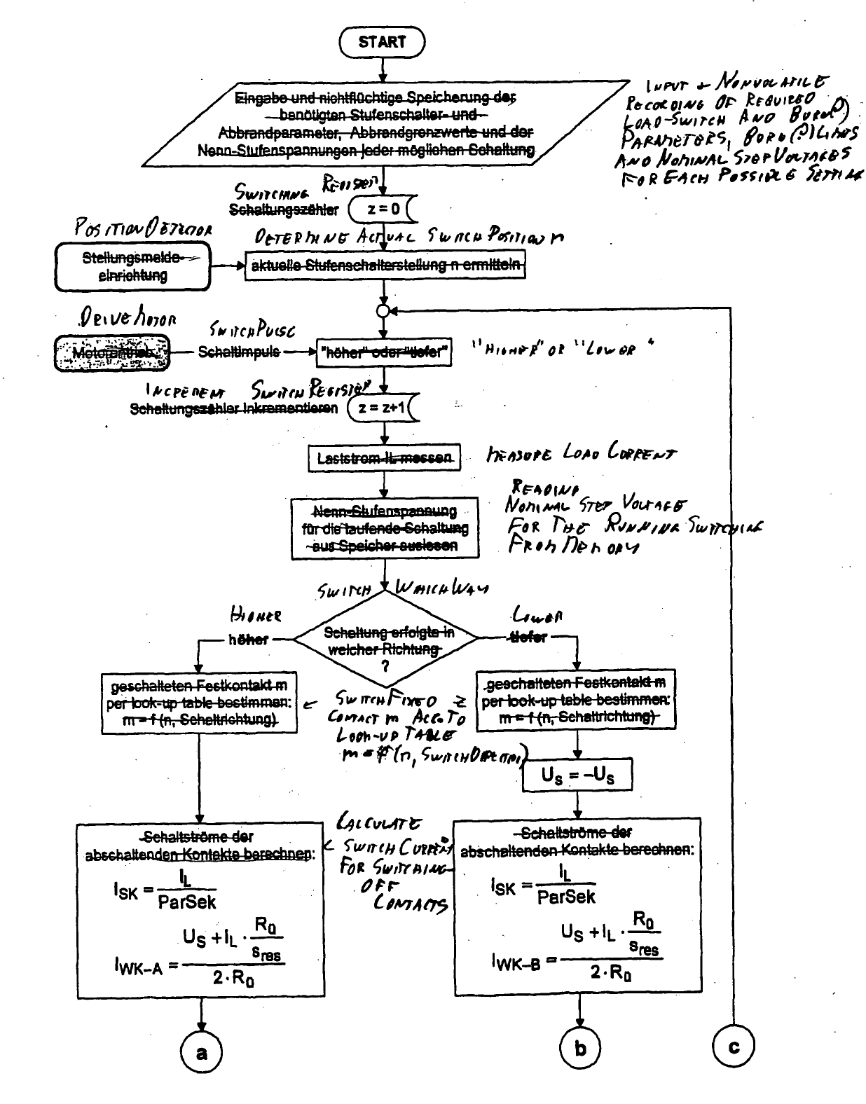

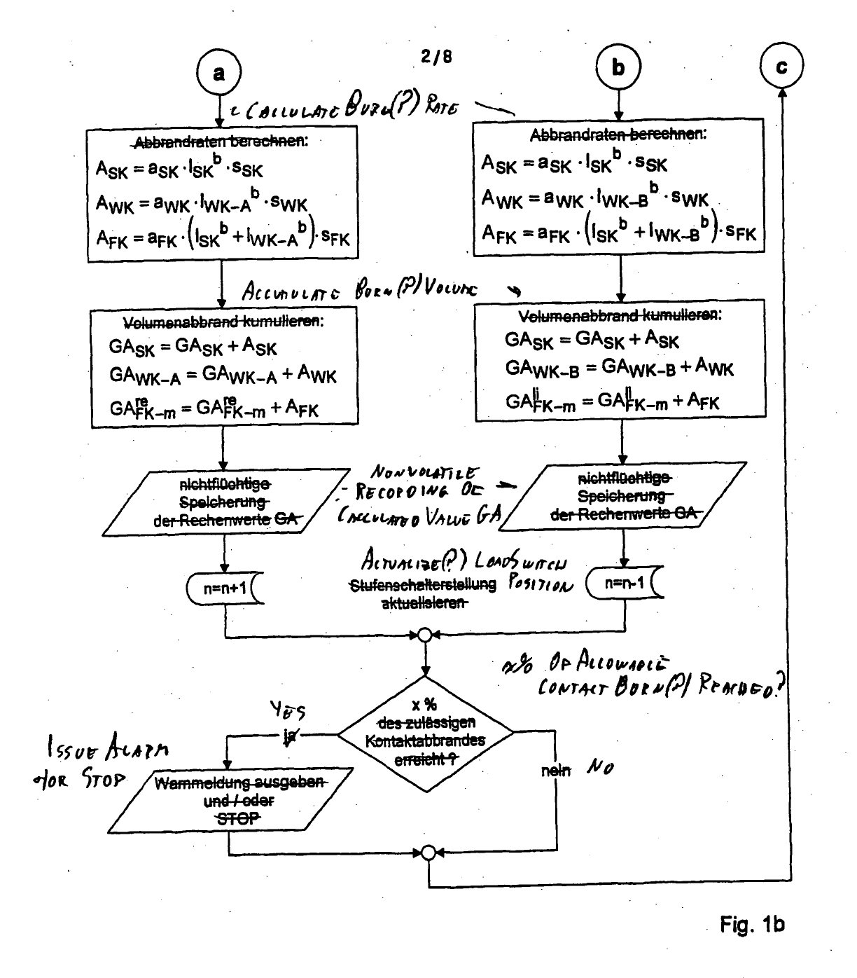

FIGS. 1a and 1b show the flow chart of a first method according to the invention;

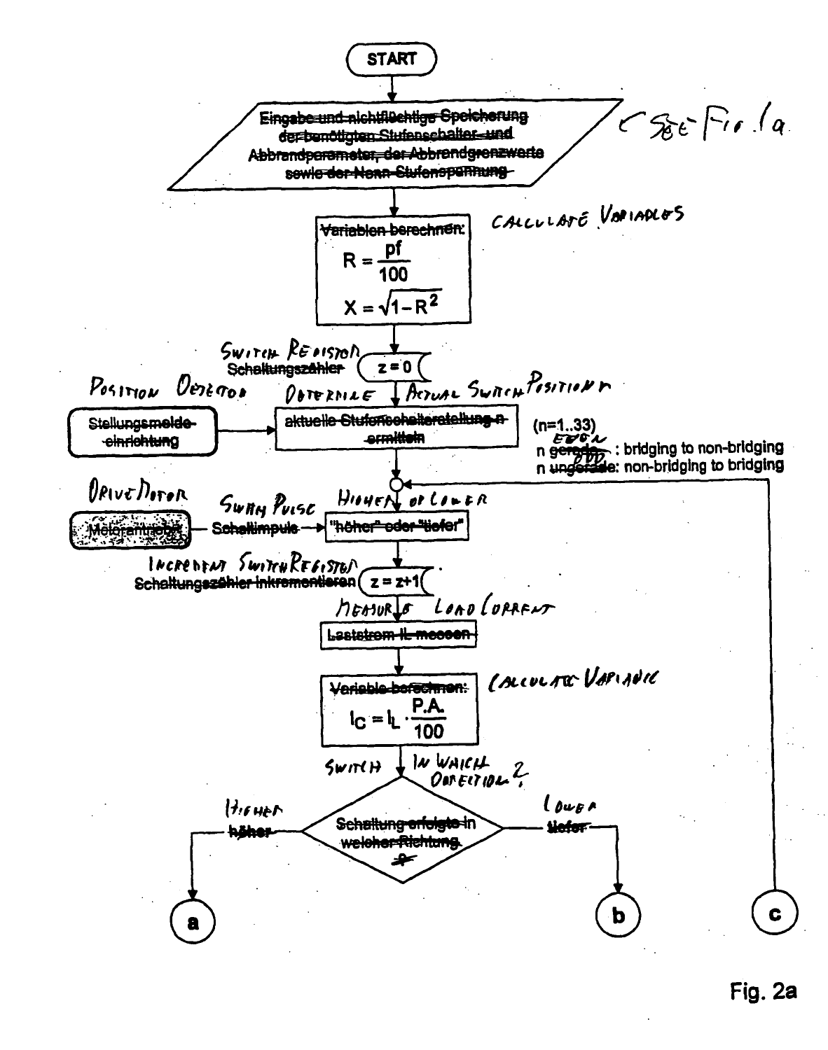

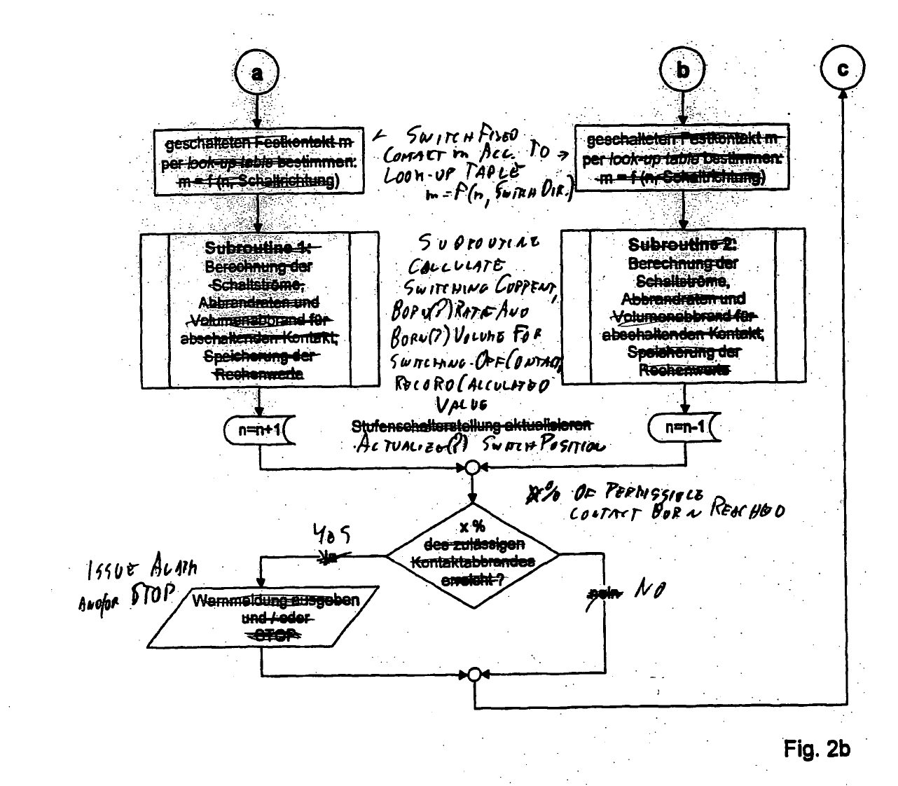

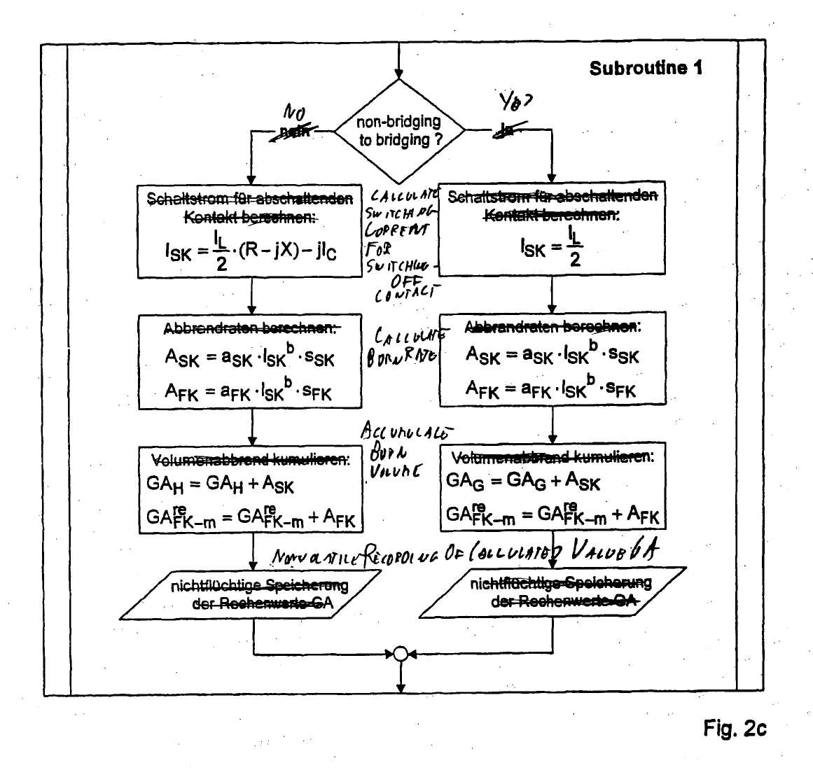

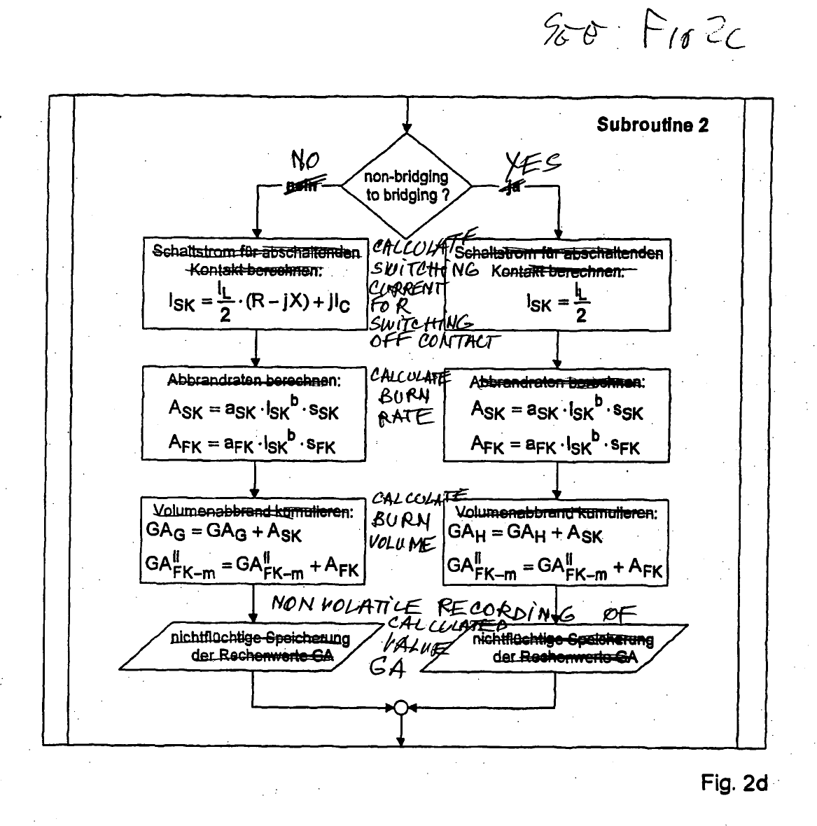

FIGS. 2a to 2d show the flow chart of a second method according to the invention;

FIG. 3 shows an assignment table for carrying out this second method;

FIGS. 4 and 5 shows principal switching modes of load selector switches according to the prior which has already been described above.

It is to be noted that FIGS. 1a and 1b belong together; they represent a single first method according to the invention. Solely for lack of space, this method had to be represented on two separate figure sheets.

Similarly, FIGS. 2a to 2d belong together; therein, as well a unique second method according to the invention is shown. Herein, it was required also for lack of space to place the representation of the method on in total 4 separate figure sheets. The details of the process flows which are designated as “subroutine” 1 or 2 respectively in FIG. 2b is represented in detail in the FIG. 2c or 2d respectively.

At first, the method represented in FIGS. 1a and 1b shall be further discussed. The basis of this method is a load selector switch with resistive transition resistances, as it is shown in FIG. 4 according to the prior art. It has already been described above, on which points contact consumption in load selector switches can occur. In the method explained herein, the load current is measured and according to the already indicated and discussed relationships, the switching currents for the contacts which are involved in the respective stage switching. From these switching currents a volume consumption A according to the relationship
A=a×l^{b}×s
is determined. Therein, a is a consumption parameter which is specific of the switch type and of the contact, the value b represents a parameter which is dependent from the employed contact material in the range of 1.1 . . . 1.9. In many cases, it is also reasonable to add a security margin s, which can advantageously be 12%. This part of the method is already known from the DE 100 03 918 B C1.

It is possible that in a certain switch type, different parameters a have to be used for the fixed contacts on the one hand and for the movable contacts on the other hand, since for example a contact roll can have a consumption characteristic which is different from that of the edge of a fixed contact.

The volume consumptions A are respectively added to the total consumptions GAₘ of the same contacts which are accumulated in the preceding switching positions of the load selector switch. Which contacts have currently been switched respectively results from the respective position, i.e., the position n of the load selector switch before the switching operation as well as the switching direction “up,”i.e. from n to n+1 or “down,” i.e. from n+1 to n. In an advantageous manner, an assignment table can be used for this selection of the involved contacts, by means of which an assignment between the multiple contact switch position n and the respectively switched fixed contact m is created. Such matrix can be deposited as stored in a non volatile manner.

In the method according to the invention, accordingly one value for the total consumption GAₘ is determined for all consumption contacts which are present in the load selector switch—fixed as well as movable, left as well as right edge. These values are respectively stored in a non volatile manner.

After every stage switching, the values for the accumulated total consumptions GAₘ of all contacts are respectively compared to the predetermined permissible threshold values. In case a threshold value is reached or exceeded in the result of this comparison, e.g. a warning message is generated, approximately at 90% of the reached threshold value, in the same manner, the load selector switch can be totally blocked in case 100% of the previously determined threshold value of the total consumption is reached. The described method, as it results from FIGS. 1a and 1b, is suitable for load selector switches with transition resistances.

FIGS. 2a to 2d show the schematic flow chart of another method according to the invention which is particularly suitable for load selector switches with transition reactance, as represented according to FIG. 5 referring to the state of the art. The individual relationships according to which required process values are determined have already been discussed in detail above. Compared to the first method represented in FIGS. 1a and 1b, the second method according to FIGS. 2a to 2d is different due to the fact that additional process steps are added. Thus, after the input and the non volatile storage of the required multiple contact switch and consumption parameters, the consumption parameters as well as the rated threshold voltage, a determination of the variables R and X is carried out in the described manner, wherein R, as described, represents the resistive component and x is the inductive component.

Further, in this method the circular current I_{C} is determined additionally after the measurement of the load current I_{L}, as already discussed as well.

Finally, in the method according to FIGS. 2a to 2d, the calculation of the respective switching current for the breaking contact, subsequently the determination of the consumption rates and again subsequently the accumulation of the respective volume consumption GA is proceeded not only separately according to the switching direction “up” or “down”. In fact, within these process steps which are dependent from the switching direction, still a further separation of the process steps is carried out which depends from whether the switching is effected from a non-bridging position to a bridging position or not. According to the situation, the switching currents of the respective applicable formulas must be determined.

For this method, an assignment table which has been previously stored in a non volatile manner (so-called “look-up table”) is applicable particularly advantageously for determining in an easy manner the fixed switched contacts involved in the respective switching operation. An example of such assignment table for execution of the second method according to FIGS. 2a to 2d is shown in the separate FIG. 3.

1. A method for monitoring the contact consumption in multiple contact switches having following features:
permanent storage of the values for the rated stage voltage (U_{S}) of any possible switching, i.e. stage, of the threshold values for the permissible contact consumption of the switching contact as well as the resistor contacts as well as the multiple contact switch-specific parameters a and b;
determination of the actual position n of the multiple contact switch;
reading the stored value for the rated stage voltage (U_{S}) which corresponds to the actual multiple contact switch position;
measuring the load current (I_{L}) at any switchover, i.e. actuation of the multiple contact switch;
determination of the switching direction “up” or “down” of the respective switchover;
determination which is independent of the switching direction of the switched, fixed contact showing consumption
calculation of the switching currents of the breaking contacts in an inherently known manner using the relationships
I_{SK}=I_{L}/ParSek
I_{WK-A}=(U_{S}+I_{L}×R_{O}/Sᵣₑₛ)/(2×R_{O)}
for the switching direction “up” and
I_{SK}=I_{L}/ParSek
I_{WK-B}=(U_{S}+I_{L}×R_{O}/Sᵣₑₛ)/(2×R_{O})
wherein U_{S}=−U_{S}
for the switching direction “down,”
wherein ParSek represents the number of parallel sectors, R₀ the magnitude of the transition resistance and Sᵣₑₛ the resulting current splitting;
calculation which is independent of the switching direction of the respective consumption rates of the switching contact (Aₛₖ), of the respective resistor contact (_{WK}) as well as of the breaking fixed contact according to the relationships
A_{SK}=a_{SK}×I_{SK}^{b}×S_{SK}
A_{WK}=a_{WK}×I_{WK-A}^{b}×S_{WK}
A_{FK}=a_{FK}×(I_{SK}^{b}+I_{WK-A}^{b})×S_{FK}
for the switching direction “up” and
A_{SK}=a_{SK}×I_{SK}^{b}×S_{SK}
A_{WK}=a_{WK}×I_{SK}^{b}×S_{WK}
A_{FK}=a_{FK}(I_{SK}^{b}+I_{WK-B}^{b})×S_{FM}
for the switching direction “down;”
summing up the respective consumption rates (A_{SK}, A_{WK}, A_{FK}) to the respective total volume consumption (GA_{SK}, GA_{WK-A}, GA_{WK-B}, GA^{re}_{FK-n}, GA^{I1}_{FK-m}), non volatile storage of all summed up total volume consumptions and comparison of these values with the respective permanently stored threshold values;
generation of messages when the respective threshold values or percentage limits thereof are exceeded.

2. A method for monitoring the contact consumption in multiple contact switches having following features:
permanent storage of the values for the rated stage voltage (U_{S}) of any possible switching, i.e. stage, of the threshold values for the permissible contact consumption of the switching contact as well as of the resistor contacts as well as the multiple contact switch-specific parameters a and b;
calculation of the resistive component R as well as the inductive component X of the transition reactance;
determination of the actual position n of the multiple contact switch;
measuring the load current (I_{L}) at any switchover, i.e. actuation of the multiple contact switch;
calculation of the circular current I_{C} a partial amount of the load current (I_{L});
determination of the switching direction “up” or “down” of the respective switchover;
determination which is dependent on the switching direction of the switched fixed contact showing consumption
determining-whether the switching is effected from a non-bridging to a bridging position or not;
calculation of the switching current of the breaking contacts respectively with the relationships
I_{SK}=I_{L}/2
for a switching from non-bridging to bridging and
I_{SK}=(I_{L}/2)×(R−jX)−jI_{C} or I_{SK}=(I_{L}/2)×(R−jX)+jI_{C}
in the alternative case;
calculation of the respective consumption rates of the switching contact (A_{SK}) and the fixed breaking contact (A_{FK}) according to the relationship
A_{SK}=a_{SK}×I_{SK}^{b}×S_{SK}
A_{FK}=a_{FK}×I_{FK}^{b}×S_{FK};
summing up the respective consumption rates (A_{SK}, A_{FK}) to the respective total volume consumption (GA_{H}, GA_{G}, GA^{re}_{FK-m}, GA^{I1}_{FK-m}), non volatile storage of all summed up total volume consumptions and comparison of these values with the respective permanently stored threshold values;
generation of messages when the respective threshold values or percentage limits thereof are being exceeded.

3. A method for monitoring contact consumption in a multiple load selector switch with transition resistance and having multiple fixed, breaking and resistor contacts, the method comprising the steps of:
determining actual position of the multiple contacts;
measuring a load current during actuation of the multiple contacts while displacing the multiple contacts between multiple switching stages;
calculating a switching current of each of the contacts;
calculating a consumption rate of each of the multiple contacts independently of the switching direction thereof;
summing up the calculated consumption rates, thereby determining a total volume consumption; and
comparing the determined volume consumption to a threshold value, thereby issuing a warning message upon reaching the threshold value or a predetermined percentage thereof.

4. A method for monitoring contact consumption in a multiple load selector switch with transition reactance, the method comprising the steps of:
calculating resistive and inductive components of the transition reactance;
determining an actual position of multiple contacts of the switch, the multiple contacts include fixed and breaking contacts;
measuring a load current at any of multiple switchover stages of the load selector switch upon actuation of the multiple contacts thereof;
calculating a circular current based on the load current;
determining a switching direction of the multiple contacts between bridging and non-bridging positions thereof during each switchover stage;
determining consumption rates of the respective multiple contacts based on the determined switching direction; and
summing up the calculated consumption rates to determined respective total volume consumption; and
comparing the stored total volume consumption to a threshold, thereby issuing a warning signal if the total volume consumption is at least equal to the threshold.
